(19) United States
(12) Patent Application Publication
(10) Pub. No.: US 2015/0346419 A1
(43) Pub. Date: Dec. 3, 2015

(54) BACKLIGHT MODULE

(71) Applicant: Radiant Opto-Electronics Corporation, Kaohsiung City (TW)

(72) Inventors: Che-Hui HUANG, Kaohsiung City (TW); Shu-An TSAI, Kaohsiung City (TW); Hui-Yu HUANG, Kaohsiung City (TW); I-Cheng LIU, Kaohsiung City (TW)

(21) Appl. No.: 14/640,714

(22) Filed: Mar. 6, 2015

(30) Foreign Application Priority Data
May 29, 2014 (TW) 103118792

(51) Int. Cl. F21V 8/00

(52) U.S. Cl. CPC G02B 6/0053; G02B 6/0055; G02B 6/0031; G02B 6/0088; G02B 6/0026

(57) ABSTRACT

A backlight module includes a light source, a light guide plate, a quantum dot enhancement film unit and a reflecting unit. The light guide plate includes a light-input side that faces the light source, and an opposite side that is opposite to the light-input side. The quantum dot enhancement film unit is laminated with the light guide plate. The reflecting unit is disposed to reflect light directed from the light guide plate into the quantum dot enhancement film unit.

### CROSS-REFERENCE TO RELATED APPLICATION

This application claims priority of Taiwanese Patent Application No. 103118792, filed on May 29, 2014, the entire disclosure of which is hereby incorporated by reference.

### FIELD OF THE INVENTION

This invention relates to a backlight module, more particularly to a backlight module capable of reducing chromatic aberration on edges of a display.

### BACKGROUND OF THE INVENTION

A quantum dot enhancement film (abbreviated as QDEF hereinafter) is an optical component used in a backlight module of a display, to enable the display to exhibit vibrant color. In practice, the backlight module uses blue light as a light source, and the QDEF containing a large number of quantum dot phosphors converts blue light into red light and green light. The red and green light mix with the blue light to generate white light. This type of white light when used as backlight of the display, allows for the best color gamut.

Referring to FIG. 1, a conventional backlight module 1 is shown to include a back plate 11, a plastic frame 12 that is connected to a periphery of the back plate 11 and that cooperates with the back plate 11 to confine a receiving space 10, a light guide plate 13 that is received in the receiving space 10, a light source (not shown) that is received in the receiving space 10 to emit light into the light guide plate 13, a QDEF 14 that is received in the receiving space 10 and that is laminated with the light guide plate 13, a reflecting unit 15 that is disposed in the receiving space 10 at a side 131 of the light guide plate 13 to reflect the light back into the light guide plate 13, and a plurality of optical films 16 that are laminated on the QDEF 14 and that are spaced apart from the plastic frame 12 to define an opening 100.

When the light travels through the light guide plate 13 and the QDEF 14 to the optical films 16, it may be reflected by the optical films 16 and return back into the QDEF 14. The number of times that the light is reflected or refracted back into the QDEF 14 would affect the quality and accuracy of color of the light. However, if the number of times is insufficient before the light is escaped from the opening 100, the display may experience chromatic aberration at an edge thereof.

### SUMMARY OF THE INVENTION

Therefore, an object of the present invention is to provide a backlight module that can overcome the aforesaid drawback of the prior art.

According to this invention, a backlight module includes a light source, a light guide plate, a quantum dot enhancement film unit and a reflecting unit. The light guide plate includes a light-input side that faces the light source, and an opposite side that is opposite to the light-input side. The quantum dot enhancement film unit is laminated with the light guide plate. The reflecting unit is disposed to reflect light directed from the light guide plate into the quantum dot enhancement film unit.

### BRIEF DESCRIPTION OF THE DRAWINGS

Other features and advantages of the present invention will become apparent in the following detailed description of the embodiments of this invention, with reference to the accompanying drawings, in which:

FIG. 1 is a fragmentary schematic side view of a conventional backlight module;

FIG. 2 is a schematic top view of the first embodiment of a backlight module according to this invention;

FIG. 3 is a fragmentary schematic side view of the first embodiment;

FIG. 4 is a fragmentary schematic view of the first embodiment, showing a first reflector disposed on a first quantum dot enhancement film;

FIG. 5 is a fragmentary schematic view of the first embodiment, showing second and third reflectors respectively disposed on second and third quantum dot enhancement films;

FIG. 6 is a fragmentary schematic side view similar to FIG. 4, showing light path in the first embodiment;

FIGS. 7 and 8 are fragmentary schematic views, showing variations of the first embodiment;

FIGS. 9 and 10 are fragmentary schematic views of the second embodiment of a backlight module according to this invention;

FIG. 11 is a fragmentary schematic view, showing a variation of the second embodiment; and

FIGS. 12 to 14 are plots showing degree of chromatic aberration versus distance from an edge of a display.

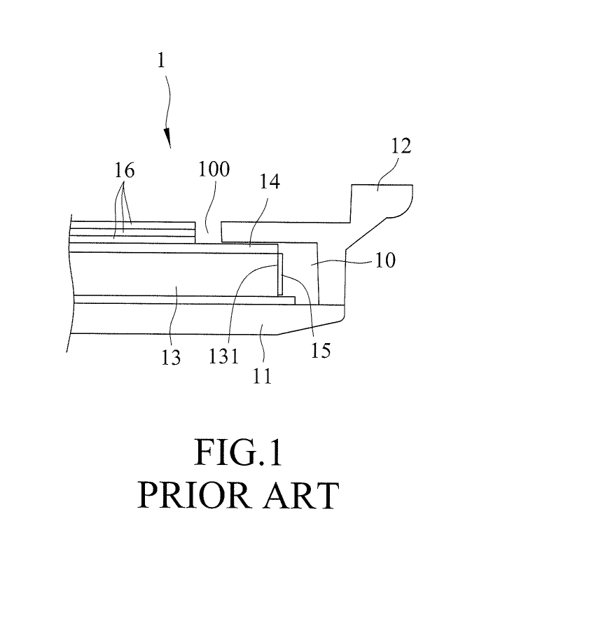

### DETAILED DESCRIPTION OF THE EMBODIMENTS

Before the present invention is described in greater detail, it should be noted that like elements are denoted by the same reference numerals throughout the disclosure.

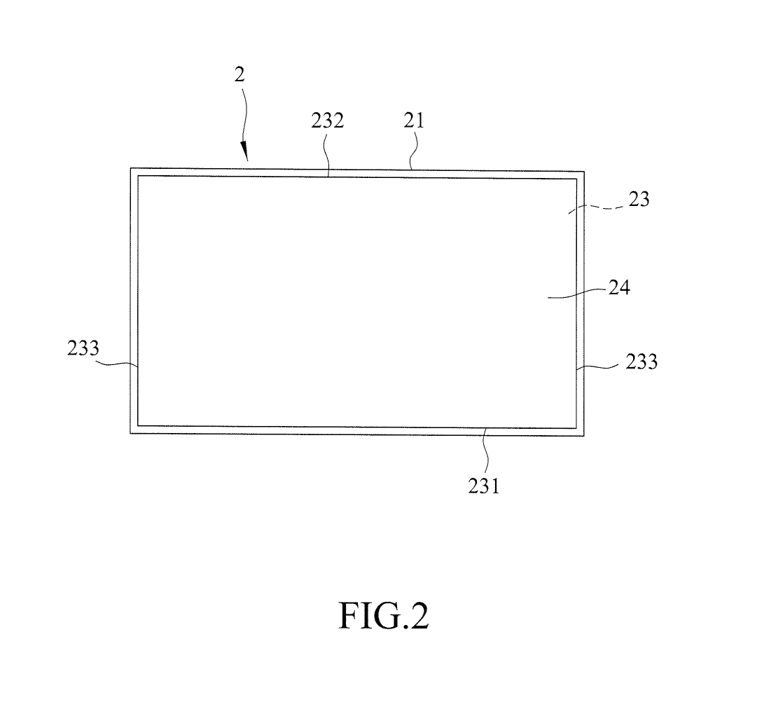

Referring to FIGS. 2 to 5, the first embodiment of a backlight module 2 according to the present invention is shown to include a light source 22, a light guide plate 23, a quantum dot enhancement film unit 24, a first reflecting unit 21, a second reflecting unit 25 and an optical unit 26.

The light source 22 emits light into the light guide plate 23. The light guide plate 23 includes a light-input side 231 that faces the light source 22, an opposite side 232 that is opposite to the light-input side 231 in a first direction (D1), and two lateral sides 233 each interconnecting an end of the light-input side 231 and an end of the opposite side 232 such that the light-input side 231, the opposite side 232 and the lateral sides 233 cooperatively define a periphery of the light guide plate 23, as best shown in FIG. 2.

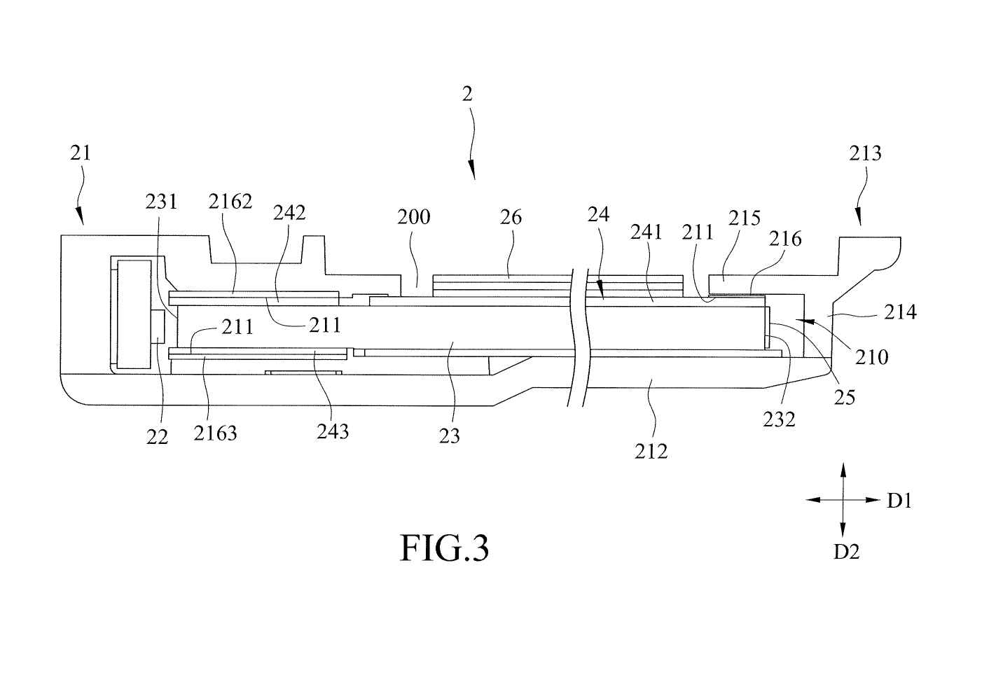

The quantum dot enhancement film unit 24 is laminated with the light guide plate 23. The first reflecting unit 21 is disposed to reflect light directed from the light guide plate 23 into the quantum dot enhancement film unit 24, and is formed with a receiving space 210 in which the light source 22, the light guide plate 23 and the quantum dot enhancement film unit 24 are disposed (see FIG. 3). In this embodiment, the first reflecting unit 21 includes a back plate 212 and a frame 213. The frame 213 has a lateral surrounding portion 214 extending upwardly from a periphery of the back plate 212 in a second direction (D2) perpendicular to the first direction (D1), and a top cover portion 215 extending from a periphery of the lateral surrounding portion 214 in the first direction (D1) such that the back plate 212 and the frame 213 cooperatively define the receiving space 210. That is to say, in this embodiment, the first reflecting unit 21 serves as a housing for the light source 22, the light guide plate 23 and the quantum dot enhancement film unit 24.

The second reflecting unit 25 is disposed in the receiving space 210 at the opposite side 232 of the light guide plate 23 to reflect light back into the light guide plate 23. The optical unit 26 is disposed on the quantum dot enhancement film unit 24 and is composed of a plurality of optical thin films and/or a plurality of optical plates. The optical unit 26 is spaced apart from the top cover portion 215 of the frame 213 so as to define an opening 200 therebetween. Since the feature of this invention does not reside in the specific configuration of the optical unit 26, which should be readily appreciated by those skilled in the art, further details thereof will be omitted herein for the sake of brevity.

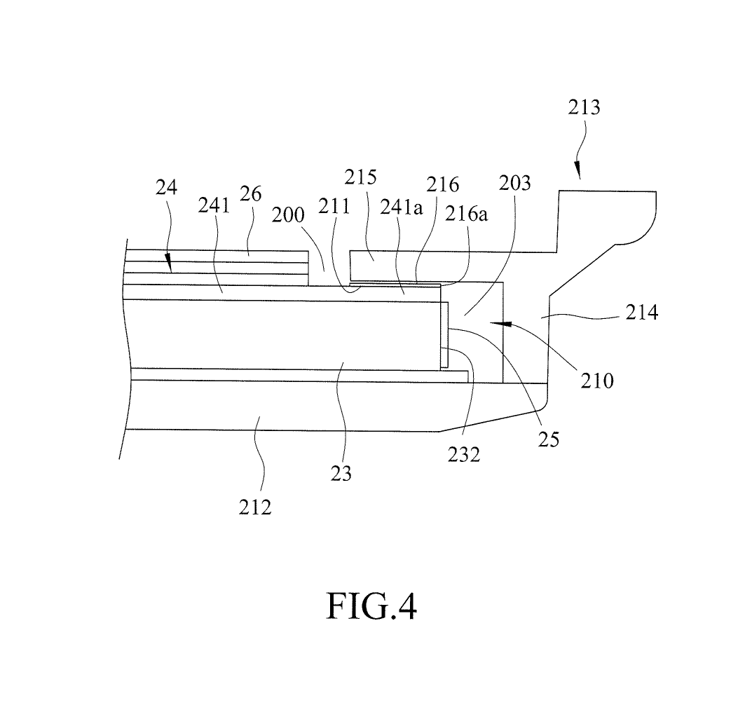

Referring to FIGS. 3 and 4, the first reflecting unit 21 further includes a first reflector 216 that has a reflecting surface 211 and that is disposed between the top cover portion 215 of the frame 213 and the quantum dot enhancement film unit 24. The quantum dot enhancement film unit 24 includes a first quantum dot enhancement film 241 disposed on the light guide plate 23 opposite to the back plate 212. The first quantum dot enhancement film 241 has an end portion 241a that is disposed between the top cover portion 215 of the frame 213 and the light guide plate 23. The first reflector 216 is formed between the end portion 241a of the first quantum dot enhancement film 241 and the top cover portion 215 of the frame 213 and the reflecting surface 211 thereof faces the end portion 241a of the quantum dot enhancement film 241. In this embodiment, the first reflector 216 has an end 216a not extending beyond the opposite side 232 of the light guide plate 23 (see FIG. 4).

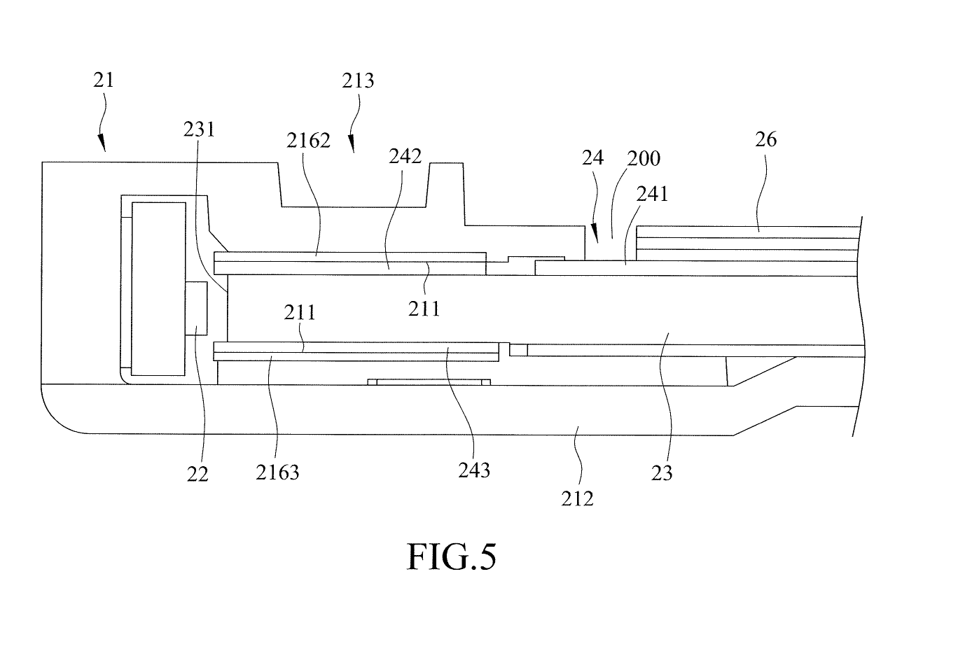

Referring to FIG. 5, the quantum dot enhancement film unit 24 further includes a second quantum dot enhancement film 242 disposed between the light guide plate 23 and the top cover portion 215 of the frame 213, more adjacent to the light source 23 than the first quantum dot enhancement film 241, and spaced apart from the first quantum dot enhancement film 241 in the first direction (D1). The first reflecting unit 21 further includes a second reflector 2162 that is disposed between the top cover portion 215 of the frame 213 and the second quantum dot enhancement film 242, and that has a reflecting surface 211 formed thereon in such a manner that the reflecting surface 211 faces the second quantum dot enhancement film 242. Furthermore, the quantum dot enhancement film unit 24 further includes a third quantum dot enhancement film 243 disposed between the light guide plate 23 and the back plate 212. The first reflecting unit 21 further includes a third reflector 2163 that is disposed between the back plate 212 and the third quantum dot enhancement film 243, and that has a reflecting surface 211 formed thereon in such a manner that the reflecting surface 211 faces the third quantum dot enhancement film 243.

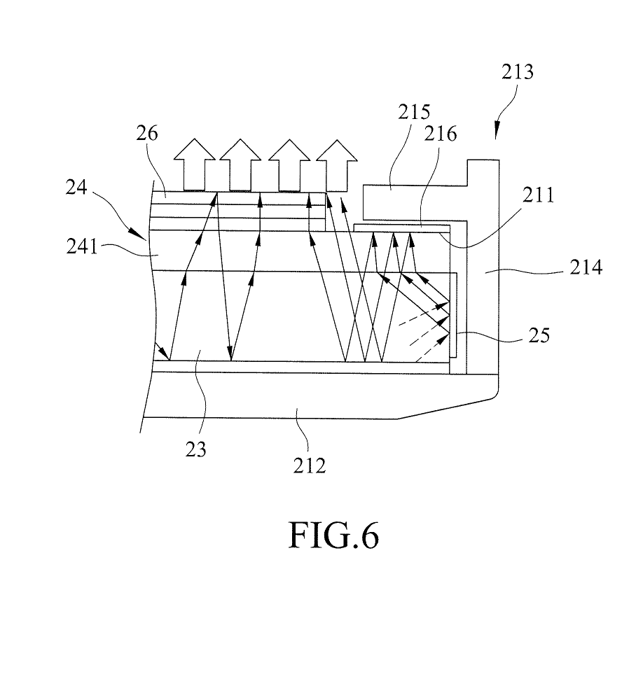

FIG. 6 is a fragmentary schematic side view similar to FIG. 4, showing light path in the backlight module of this embodiment. As shown in FIG. 6, a portion of the light in the light guide plate 23 travels to the second reflecting unit 25 and is reflected back into the light guide plate 23 by the second reflecting unit 25. The portion of the light then travels through the light guide plate 23 and the quantum dot enhancement film unit 24 to the first reflector 216 and then is reflected by the reflecting surface 211 of the first reflector 216 back into the first quantum dot enhancement film 241. Therefore, the reflecting surface 211 of the first reflector 216 increases the frequency of the light passing through the quantum dot enhancement film unit 24 before the light is escaped from the opening 200. Therefore, when the backlight module of the embodiment is used in a display, chromatic aberration in the display could be alleviated.

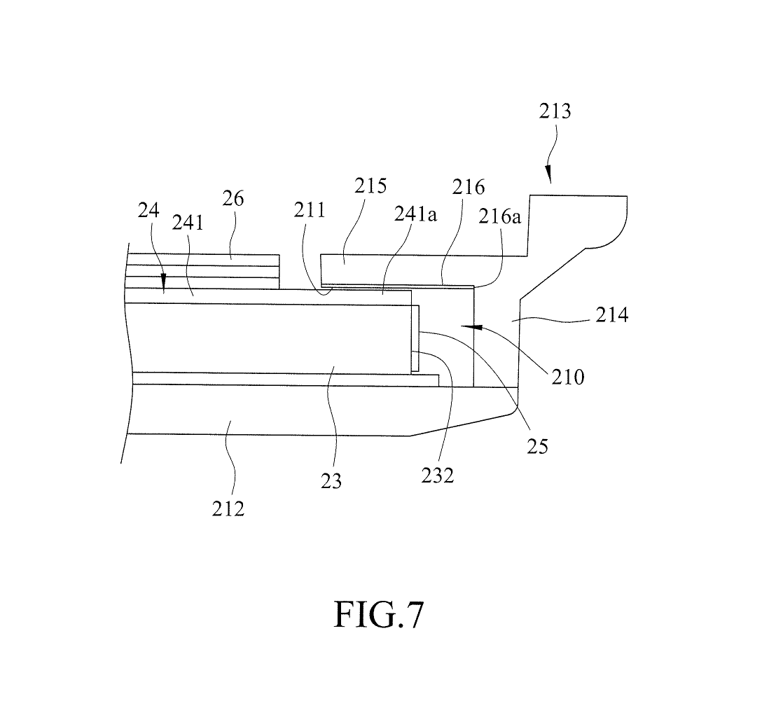

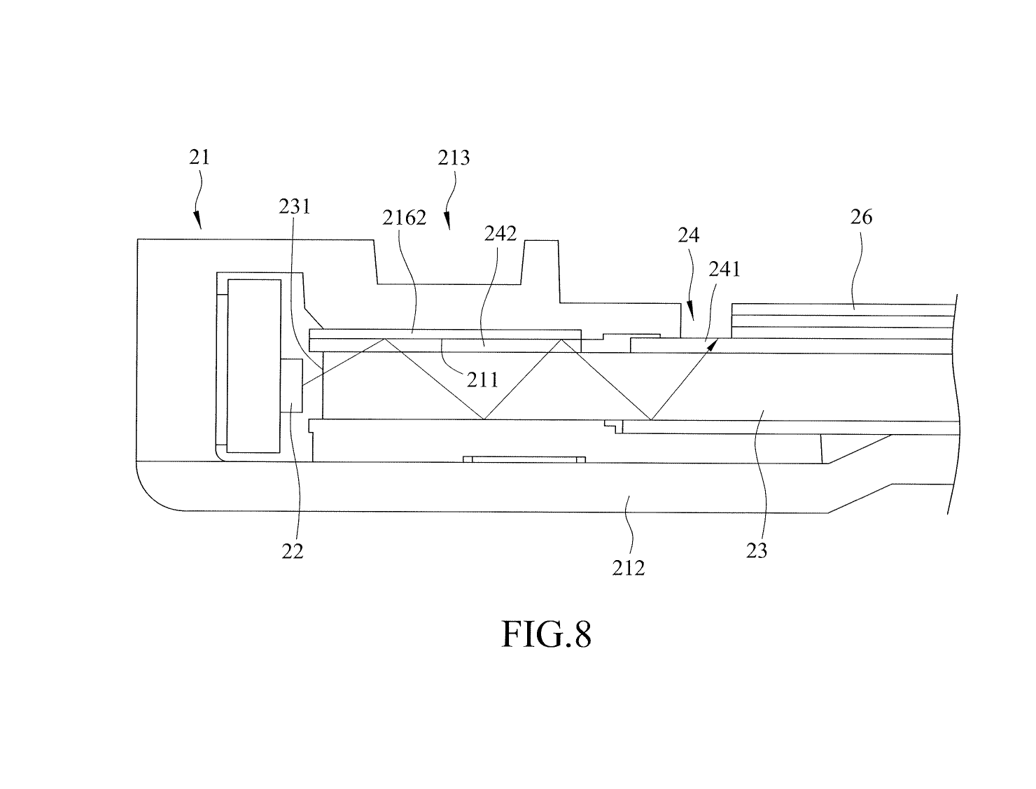

FIGS. 7 and 8 show variations of the first embodiment. In FIG. 7, the end 216a of the first reflector 216 extends beyond the opposite side 232 of the light guide plate 23 and extends to contact the lateral surrounding portion 214 of the frame 213, and the first reflector 216 is laminated with the top cover portion 215 of the frame 213. Alternatively, as shown in FIG. 8, the third quantum dot enhancement film 243 and the third reflector 2163 could be omitted based on actual requirements.

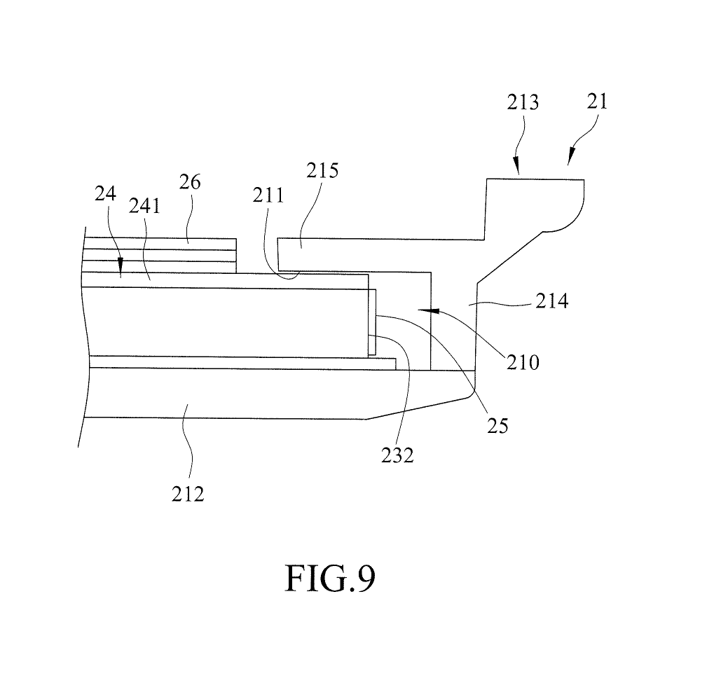

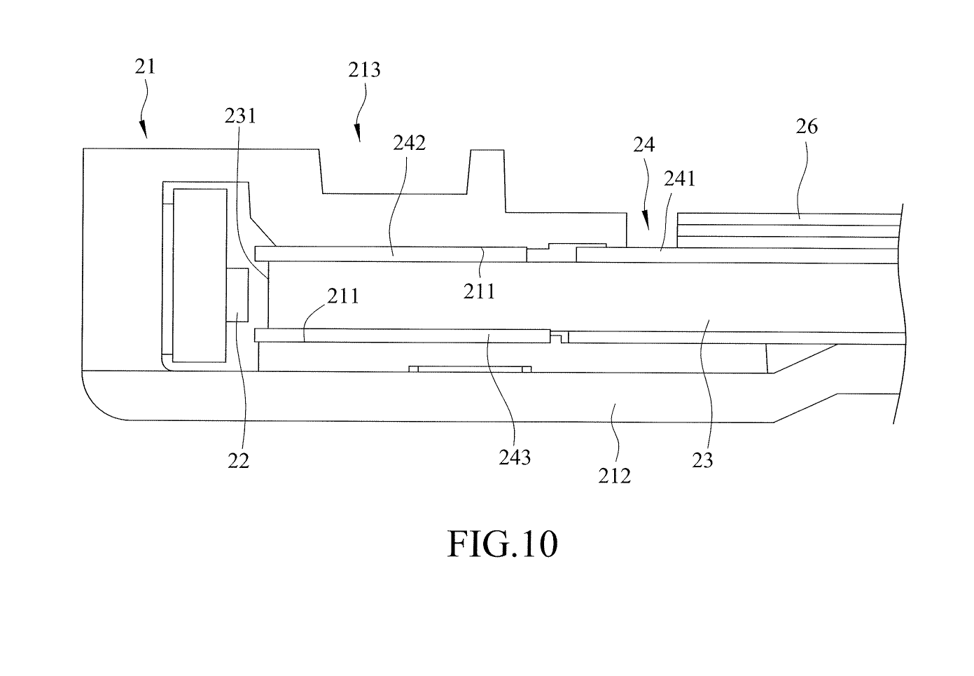

FIGS. 9 and 10 illustrate the second embodiment of the backlight module according to this invention. The differences between the first and second embodiments reside in that the back plate 212 and the top cover portion 215 of the frame 213 are made of a light reflective material, and the first, second and third reflectors 216, 2162, 2163 of the reflecting unit 21 are omitted in this embodiment. To be more specific, the top cover portion 215 of the frame 213 and the back plate 212 are formed with reflecting surfaces 211 that respectively face the first, second, and third quantum dot enhancement films 241, 242, 243 to reflect light back into the quantum dot enhancement film unit 24.

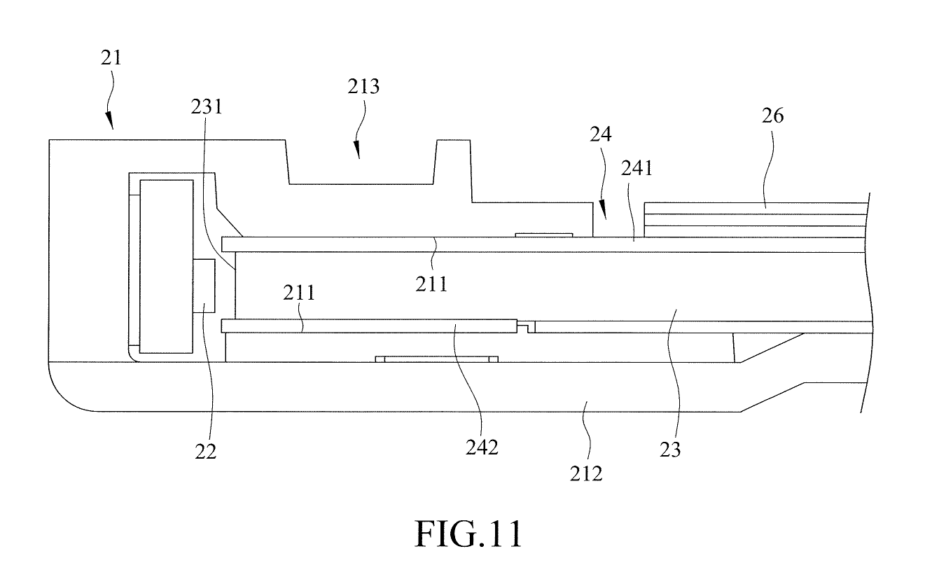

FIG. 11 shows a variation of the second embodiment. In this variation, the first quantum dot enhancement film 241 of the quantum dot enhancement unit 24 is formed entirely on the light guide plate 23 opposite to the back plate 212. The second quantum dot enhancement film 242 is disposed between the light guide plate 23 and the back plate 212.

### <Tests and Results>

A 27-inch display was installed with a backlight module (the backlight module according to this invention or a conventional backlight module) and was subjected to a test to measure chromatic aberration effect on edges of the display.

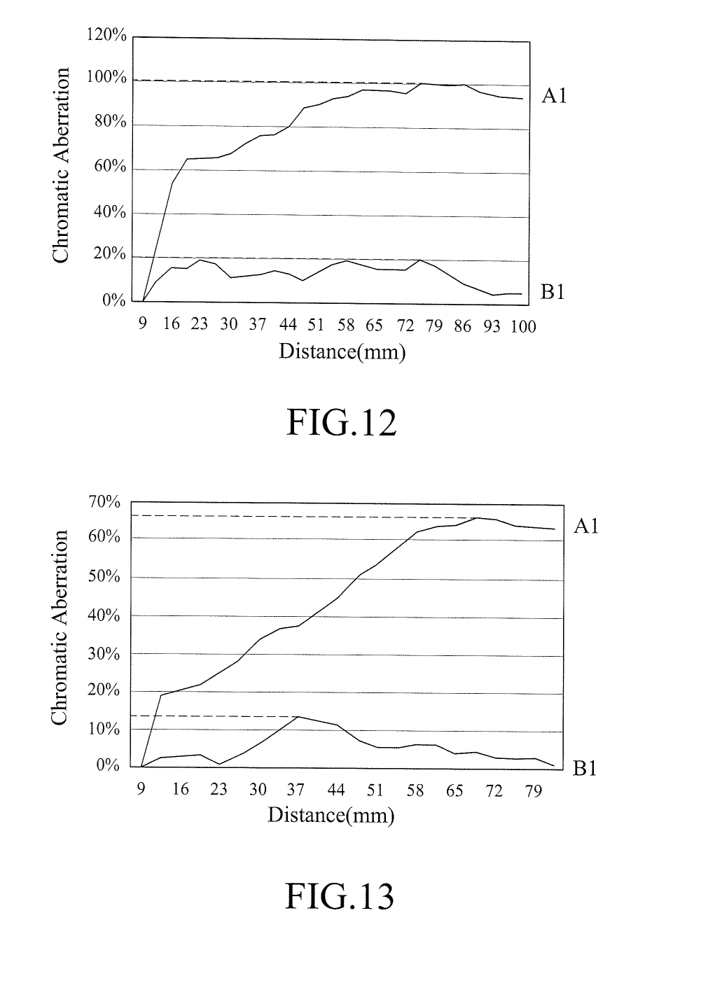

FIGS. 12 to 14 are plots showing degree of chromatic aberration versus distance from an edge of the display, in which A1 represents a result of the display provided with the conventional backlight module (hereinafter referred to as “the conventional display”), while B1 represents a result of the display provided with the backlight module of the present invention (hereinafter referred to as “the exemplary display”).

FIG. 12 shows the results measured at the opposite side 232 of the light guide plate 23. As shown in FIG. 12, line A1 shows that degree of chromatic aberration of the conventional display increases dramatically as the distance from the edge to the center of the display increases, and reaches the highest value of 100% when the distance is within the range of about 76 to 86 mm. The degree of chromatic aberration then decreases as the distance from the edge continues to increase. On the other hand, line B1 shows that degree of chromatic aberration of the exemplary display increases gently as the distance from the edge to the center of the display increases, and reaches about 20% when the distance is about 23 mm. The degree of chromatic aberration is then maintained not greater than 20% as the distance from the edge continues to increase. The results show that the degree of chromatic aberration of the exemplary display is smaller than that of the conventional display, which indicates that the chromatic aberration effect in the exemplary display is significantly reduced.

FIG. 13 shows the results measured at the lateral sides 233 of the light guide plate 23. As shown in FIG. 13, line A1 shows that degree of chromatic aberration of the conventional display increases dramatically as the distance from the edge to the center of the display increases, and reaches the highest value of 66% when the distance reaches about 68 mm. The degree of chromatic aberration then decreases as the distance from the edge continues to increase. On the other hand, line B1 shows that degree of chromatic aberration of the exemplary display increases gently as the distance from the edge to the center of the display increases, and reaches about 13% when the distance is about 37 mm. The degree of chromatic aberration then decreases as the distance continues to increase. The results show that the degree of chromatic aberration of the exemplary display is smaller than that of the conventional display, which indicates trends similar to those shown in FIG. 12, thereby leading to the same conclusion.

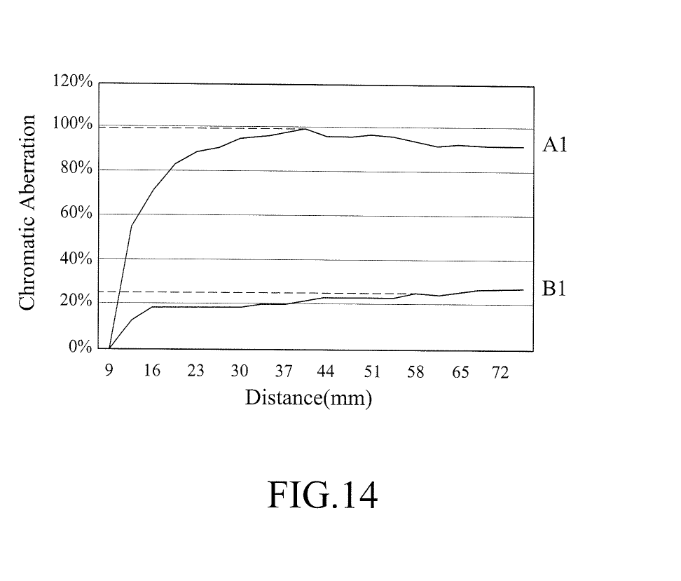

FIG. 14 shows the results measured at the light-input side 231 of the light guide plate 23. As shown in FIG. 14, line A1 shows that degree of chromatic aberration of the conventional display increases dramatically as the distance from the edge to the center of the display increases, and reaches the highest value of 100% when the distance reaches about 44 mm. The degree of chromatic aberration then decreases as the distance from the edge continues to increase. On the other hand, line B1 of the exemplary display shows that degree of chromatic aberration increases gently as the distance from the edge to the center of the display increases, and is then maintained not greater than 23% when the distance continues to increase. The results show trends similar to those shown in FIGS. 12 and 13. Therefore, the chromatic aberration effect in the exemplary display is significantly reduced.

To sum up, through configuration of the reflecting surface(s) 211 of the first reflecting unit 21 to reflect light into the quantum dot enhancement film unit 24, the number of times the light passes through the quantum dot enhancement film unit 24 before escaping from the opening 200 is increased, thereby reducing the chromatic aberration effect occurred on the edge of a display, that utilizes the backlight module.

While the present invention has been described in connection with what are considered the most practical embodiments, it is understood that this invention is not limited to the disclosed embodiments but is intended to cover various arrangements included within the spirit and scope of the broadest interpretation and equivalent arrangements.

What is claimed is:

1. A backlight module, comprising:
a light source;
a light guide plate including a light-input side that faces said light source, and an opposite side that is opposite to said light-input side in a first direction;
a quantum dot enhancement film unit laminated with said light guide plate; and
a first reflecting unit that is disposed to reflect light directed from said light guide plate into said quantum dot enhancement film unit.

2. The backlight module as claimed in claim 1, wherein said first reflecting unit is formed with a receiving space in which said light source, said light guide plate and said quantum dot enhancement film unit are disposed.

3. The backlight module as claimed in claim 2, wherein said first reflecting unit includes
a back plate, and
a frame that has a lateral surrounding portion extending upwardly from a periphery of said back plate in a second direction perpendicular to the first direction, and a top cover portion extending from a periphery of said lateral surrounding portion in the first direction such that said back plate and said frame cooperatively define said receiving space.

4. The backlight module as claimed in claim 3, further comprising a second reflecting unit that is disposed in said receiving space at said opposite side of said light guide plate to reflect light into said light guide plate.

5. The backlight module as claimed in claim 3, wherein said first reflecting unit further includes a first reflector that is disposed between said top cover portion of said frame and said quantum dot enhancement film unit.

6. The backlight module as claimed in claim 5, wherein said quantum dot enhancement film unit includes a first quantum dot enhancement film disposed on said light guide plate opposite to said back plate, said first quantum dot enhancement film having an end portion that is disposed between said top cover portion of said frame and said light guide plate, said first reflector being formed between said end portion of said first quantum dot enhancement film and said top cover portion of said frame.

7. The backlight module as claimed in claim 6, wherein said first reflector has an end not extending beyond said opposite side of said light guide plate.

8. The backlight module as claimed in claim 6, wherein said first reflector has an end extending beyond said opposite side of said light guide plate.

9. The backlight module as claimed in claim 6, wherein said first reflector is laminated with said end portion of said first quantum dot enhancement film.

10. The backlight module as claimed in claim 6, wherein said first reflector is laminated with said top cover portion of said frame.

11. The backlight module as claimed in claim 6, wherein said quantum dot enhancement film unit further includes a second quantum dot enhancement film disposed between said light guide plate and said top cover portion of said frame, more adjacent to said light source than said first quantum dot enhancement film, and spaced apart from said first quantum dot enhancement film in the first direction, said first reflecting unit further including a second reflector that is disposed between said top cover portion of said frame and said second quantum dot enhancement film.

12. The backlight module as claimed in claim 11, wherein said quantum dot enhancement film unit further includes a third quantum dot enhancement film disposed between said light guide plate and said back plate, said first reflecting unit further including a third reflector that is disposed between said back plate and said third quantum dot enhancement film.

13. The backlight module as claimed in claim 6, wherein said quantum dot enhancement film unit further includes a second quantum dot enhancement film disposed between said light guide plate and said back plate, said first reflecting unit further including a second reflector that is disposed between said back plate and said second quantum dot enhancement film.

14. The backlight module as claimed in claim 3, wherein said back plate and said top cover portion of said frame are made of a light reflective material.

15. The backlight module as claimed in claim 14, wherein said quantum dot enhancement film unit includes a first quantum dot enhancement film disposed on said light guide plate opposite to said back plate, said first quantum dot enhancement film having an end portion that is disposed between said top cover portion and said light guide plate.

16. The backlight module as claimed in claim 15, wherein said quantum dot enhancement film unit further includes a second quantum dot enhancement film disposed between said light guide plate and said top cover portion of said frame, more adjacent to said light source than said first quantum dot enhancement film, and spaced apart from said first quantum dot enhancement film in the first direction.

17. The backlight module as claimed in claim 15, wherein said quantum dot enhancement film unit further includes a second quantum dot enhancement film disposed between said light guide plate and said back plate.

18. The backlight module as claimed in claim 14, wherein said quantum dot enhancement film unit is formed entirely on said light guide plate opposite to said back plate.
